(19) United States
(12) Patent Application Publication
(10) Pub. No.: US 2010/0191780 A1
(43) Pub. Date: Jul. 29, 2010

(54) Uploading a Hierarchical File Structure Using a Web Service

(76) Inventor: Colin Kroll, Hoboken, NJ (US)

Correspondence Address: STATTLER - SUH PC, 60 SOUTH MARKET STREET, SUITE 480, SAN JOSE, CA, 95113, US

(21) Appl. No.: 12/361,937

(22) Filed: Jan. 29, 2009

(51) Int. Cl. G06F 17/30; G06F 12/16

(52) U.S. Cl. 707/822; 707/E17.008; 707/E17.01; 707/E17.044; 707/E17.117; 707/E17.107

(57) ABSTRACT

A method and a system are provided for uploading a hierarchical file structure using a web service. The method and the system automate the uploading process of an ad agency and substantially reduce the number of operations that the ad agency must perform to upload ad creatives. In one example, the system encodes an archive from a library to generate an encoded archive that is compatible with a virtual library device. The archive has a hierarchical file structure for folders and files of the archive. The system then uploads the encoded archive. The uploading includes translating the encoded archive into virtual folders and virtual files of a virtual archive.

### FIELD OF THE INVENTION

The invention relates to online ad campaigns. More particularly, the invention relates to uploading hierarchical file structures of online ad campaigns using a web service.

### BACKGROUND

Electronic ad exchanges, including online auctions and guaranteed deliveries, have proliferated along with the Internet. These electronic exchanges aim to provide a high degree of trading efficiency by bringing together a large number of buyers and sellers. Such exchanges are focused on directly matching the bids and offers of buyers and sellers. Conventional transactions on the exchange are between (i) buyers and sellers, (ii) intermediaries (e.g., brokers, which may be a buyer or seller), or (iii) buyers or sellers and intermediaries.

The proliferation of Internet activity has also generated tremendous growth for advertising on the Internet. Typically, advertisers (i.e., buyers of ad space) and online publishers (sellers of ad space) have agreements with one or more advertising networks (ad networks), which provide for serving an advertiser's banner or ad across multiple publishers, and concomitantly provide for each publisher having access to a large number of advertisers. Ad networks (which may also manage payment and reporting) may also attempt to target certain Internet consumers 105 with particular advertisements to increase the likelihood that the consumer will take an action with respect to the ad. From an advertiser's perspective, effective targeting is important for achieving a high return on investment (ROI).

Online advertising markets exhibit undesirable inefficiencies when buyers and sellers are unable to transact. For instance, although a publisher may be subscribed to many ad networks, and one or more of those ad networks may transact inventory with other ad networks, only one of the ad networks to which the publisher is subscribed will be involved in selling (e.g., auctioning or guaranteeing delivery) a given ad space for the publisher. The publisher, or a gatekeeper used by the publisher, selects or prioritizes which ad network (or advertiser having a direct agreement with the publisher) will serve the impression for a given ad request.

Further, in online display advertising, advertisers may wish to target broad consumer segments (e.g., California consumers) or specific consumer segments (e.g., males of ages 20-34 in California browsing finance pages). Advertisers need the ability to specify succinctly their values for and exposure (i.e., number of ad views) to various consumer segments, from broad to narrow.

Advertisers spend long hours specifying an ad campaign which, most of the time, ends up not being portable. Once an ad campaign is written down into a contract, a company such as Yahoo!® invests long hours translating the ad campaign into scripts which are used to access the inventory and allocate ads.

Driven by the shift from broadcast to interactive media, almost every aspect of advertising is being automated, including its sale, delivery, and measurement. Moving away from the real estate metaphor of buying space, advertisers may now buy highly specific contextual events like “male consumer visits sports page on the weekend”, or may buy more general bundles of contextual events. As a result, advertisers need more flexible and expressive ways to describe their ad campaign goals.

A single ad campaign may contain thousands of interrelated files that need to be uploaded, managed and organized at the location of an ad distributor (e.g., web server). Methods for uploading an ad campaign to the ad distributor are lacking in efficiency. For example, in many case, each file must be uploaded to the distributor one at a time. Further, the files may be disorganized with respect to each other once the files are uploaded.

### SUMMARY

What is needed is an improved method having features for addressing the problems mentioned above and new features not yet discussed. Broadly speaking, the invention fills these needs by providing a method and a system for uploading a hierarchical file structure using a web service. The method and the system automate the uploading process of an ad agency and substantially reduce the number of operations that the ad agency must perform to upload ad creatives. It should be appreciated that the invention can be implemented in numerous ways, including as a method, a process, an apparatus, a system or a device. Inventive embodiments of the invention are summarized below.

In one embodiment, a method is provided for uploading a hierarchical file structure. The method comprises encoding an archive from a library to generate an encoded archive that is compatible with a virtual library device, wherein the archive has a hierarchical file structure for folders and files of the archive. The method the uploads the encoded archive, wherein the uploading includes translating the encoded archive into virtual folders and virtual files of a virtual archive.

In another embodiment, a system is provided for uploading a hierarchical file structure. The system is configured for encoding an archive from a library to generate an encoded archive that is compatible with a virtual library device, wherein the archive has a hierarchical file structure for folders and files of the archive. The system is also configured for uploading the encoded archive, wherein the uploading includes translating the encoded archive into virtual folders and virtual files of a virtual archive.

In still another embodiment, a computer readable medium carrying one or more instructions for uploading a hierarchical file structure is provided. The one or more instructions, when executed by one or more processors, cause the one or more processors to perform the steps of encoding an archive from a library to generate an encoded archive that is compatible with a virtual library device, wherein the archive has a hierarchical file structure for folders and files of the archive; and uploading the encoded archive, wherein the uploading includes translating the encoded archive into virtual folders and virtual files of a virtual archive.

The invention encompasses other embodiments configured as set forth above and with other features and alternatives.

### BRIEF DESCRIPTION OF THE DRAWINGS

The invention will be readily understood by the following detailed description in conjunction with the accompanying drawings. To facilitate this description, like reference numerals designate like structural elements.

FIG. 1 shows exemplary exchange entities of an ad exchange, in accordance with some embodiments;

FIG. 2 is a block diagram of a system for uploading a hierarchical file structure using a web service, in accordance with some embodiments;

FIG. 3 is a block diagram of a system for uploading a hierarchical file structure, with an exemplary placement of exchange entities, in accordance with some embodiments;

FIG. 4 is a hierarchical file structure for a portion of an archive, in accordance with some embodiments; and

FIG. 5 is a flowchart of a method for uploading a hierarchical file structure using a web service, in accordance with some embodiments.

### DETAILED DESCRIPTION

An invention is disclosed for uploading a hierarchical file structure using a web service. Numerous specific details are set forth in order to provide a thorough understanding of the invention. It will be understood, however, to one skilled in the art, that the invention may be practiced with other specific details.

### Definitions

Some terms are defined below for clarity purposes. These terms are not rigidly restricted to these definitions. These terms and other terms may also be defined by their use in the context of this description.

“Ad creative” (i.e., “creative”) means a graphic or movie of some kind that is typically created by an artist to convey an ad message. An ad creative is the physical portion of an ad, in other words, the raw reusable portion of the ad. An ad creative does not directly pertain to performance metrics or ad campaign goals.

“Ad exchange” means an auction marketplace for ads to connect online publishers with advertisers, ad agencies and/or ad networks. Ad space buyers (e.g., advertisers) get immediate access to inventory that meets campaign goals. Ad space sellers (e.g., online publishers) capture additional revenue and increase overall yield by reducing unsold and undervalued inventory (e.g., ad space).

“Ad agency” means an entity that handles an ad campaign, or a portion thereof, on behalf of an advertiser. An ad agency typically develops an ad creatives library for the ad campaign of an advertiser.

“Computer” (i.e., “user computer” or “client” or “server”) may refer to a single computer or to a system of interacting computers. A computer is a combination of a hardware system, a software operating system and perhaps one or more software application programs. Examples of a computer include without limitation a laptop computer, a palmtop computer, a smart phone, a cell phone, a mobile phone, an IBM-type personal computer (PC) having an operating system such as Microsoft Windows®, an Apple® computer having an operating system such as MAC-OS, hardware having a JAVA-OS operating system, and a Sun Microsystems Workstation having a UNIX operating system.

“Content delivery network” (i.e., “content distribution network” or “CDN”) is a system of computers networked together across the Internet that cooperate transparently to deliver content most often for the purpose of improving performance, scalability, and cost efficiency, to end users.

“Device” means hardware, software or a combination thereof. A device may sometimes be referred to as an apparatus. Each device is configured to carry out one or more steps of the method for uploading a hierarchical file structure using a web service.

“Library” means a database that describes a hierarchy of ad creatives, wherein the hierarchy includes pointers to ad creatives stored in a storage medium. A library is typically operated and maintained by an ad agency.

“Network” means any combination of electronic networks, including without limitation the Internet, a local area network, a wide area network, a wireless network and/or a cellular network.

“Virtual library” means a database that is configured to store a hierarchical file structure uploaded from a library of a user, such as an ad agency.

“ZIP file format” is a data compression and archive format. A ZIP file contains one or more files that have been compressed using the ZIP file format to reduce file size, or to store as-is.

“Zipping” means encoding a folder and/or file using the ZIP file format. The encoding may include compressing and archiving the file.

For implementations of the present system, a software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java and Java Scripts. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separation section below.

### Overview of Architecture

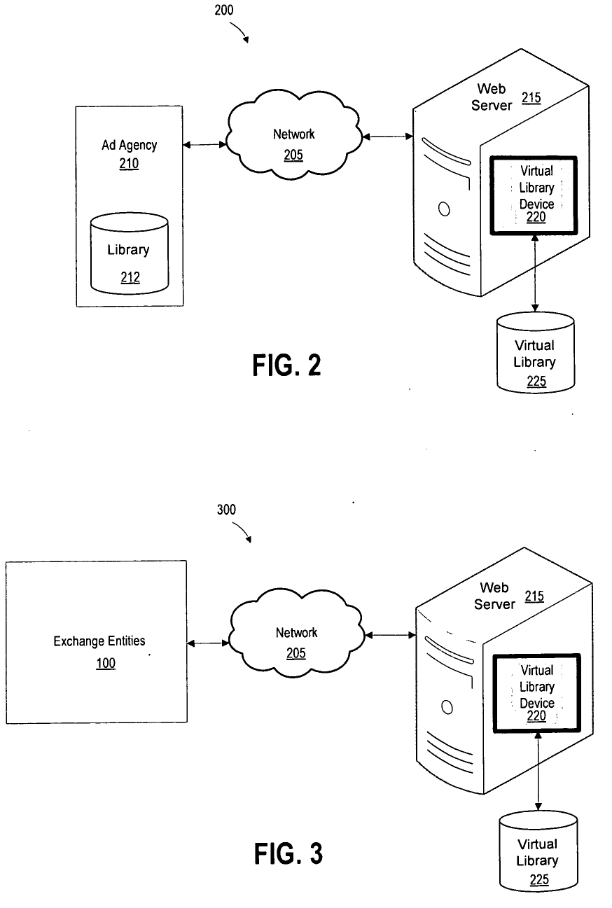

FIG. 2 is a block diagram of a system 200 for uploading a hierarchical file structure using a web service, in accordance with some embodiments. The network 205 couples together an ad agency 210 and a web server 215. The ad agency includes, or has access to, a library 212. The ad agency may alternatively be any user.

A virtual library device 220 resides in the web server 215. The virtual library device 220 carries out the more important operations of the system 200. The virtual library device 220 is coupled to a virtual library 225. The web server 215 and the virtual library 225 may be in communication with a CDN (not shown) that stores and/or manages uploaded files (e.g., ad creatives).

In some embodiments, the virtual library device 220 may reside elsewhere besides the web server 215. For example, the virtual library device 220 may reside in an ad server (not shown) coupled to the network 205, or in an application server (not shown) coupled to the network 205. The ad agency 210 may communicate with the virtual library device 220 through an interface at a computer (not shown) coupled to the network 205.

### Uploading a Hierarchical File Structure

Referring to FIG. 2, the virtual library device 220 provides a web service that allows users, such as ad agencies 210, to upload an encoded archive of folders and files (e.g., ad creatives) to the virtual library 225. For example, the virtual library device 220 allows an ad agency 210 to upload a new archive or to synchronize its library 212 (i.e., disks) with the virtual library 225. The virtual library device 220 effectively automates the uploading process of ad creatives of an ad campaign.

The uploading process is necessary in order for campaign managers later to manage the ad creatives. The uploading process is also necessary in order for the web server 215 later to deliver ads to consumer computers. Without the uploaded ad creatives, campaign managers cannot manage the ad creatives and the web server 215 cannot ultimately deliver the corresponding ads.

The folders and files to be uploaded may be encoded using the ZIP file format. Other encoding formats are feasible as well. The virtual library device 220 provides a web service in the form of an interface that is the portal for the user to communicate with the virtual library device 220. The virtual library device 220 may utilize SOAP (simple object access protocol) to upload files. Other protocols are feasible as well. The files to be uploaded may include without limitation flash files and ad creatives.

Access via the web service provided by the virtual library device 220 allows for system to system communication. For example, the system of the ad agency 210 may communicate with the system of the web server 215 and automate the uploading of the library 212 to the virtual library 225. The structural hierarchy of the archive in the library 212 is preserved. Each folder in the archive of the library 212 translates to its substantially equivalent virtual path in the virtual library 225.

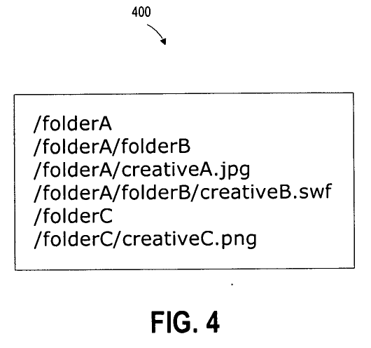

FIG. 4 is a hierarchical file structure 400 for a portion of an archive, in accordance with some embodiments. An interface at the ad agency 212 may be configured to show the hierarchical file structure to the user if the user so desires. Folder A is organized as “/folderA” in this hierarchical file structure 400. Folder B is inside Folder A and is organized as “/folderA/folderB” in this hierarchical file structure 400. Creative A is a JPEG file inside Folder A and is organized as “/folderA/creativeA.jpg” in this hierarchical file structure 400. Creative B is a Shockwave Flash file inside Folder B and is organized as “/folderA/folderB/creativeB.swf” in this hierarchical file structure 400. Folder C is organized as “/folderC” in this hierarchical file structure 400. Creative C is a Portable Networks Graphics file inside Folder C and is organized as “/folderC/creativeC.png” in this hierarchical file structure 400. One root folder (not shown) may be at a higher level and may encompass all these folders of this hierarchical file structure 400.

Referring to FIG. 2, the virtual library device 220 uploads the archive. Folder A, Folder B and Folder C are translated to virtual folders in the virtual library 225. The hierarchy of the archive is preserved. Such hierarchical consistency is useful for many different projects, including without limitation backups of ad creatives folders, ad creatives files and/or hierarchical ordering schemes. An ordering scheme is a set of rules and metrics for a purchaser to order ads.

For explanatory purposes, FIG. 2 shows a relatively shallow hierarchical file structure that includes a subfolder (Folder B) that is only two folder levels deep. Folder A and Folder C are only one folder level deep. A deeper hierarchical file structure is feasible and may include as many as 100 folder levels or more. The automated uploading mechanism of the virtual library device 220 is increasingly more useful as the hierarchical file becomes deeper and/or more complex.

It is no longer necessary for authors of ad creatives to go through the laborious tasks of saving a single file, uploading a single file, saving another single file, uploading another single file, etc. Using the virtual library device 220, an ad agency 210 may now save files (e.g., ad creatives), encode the root folder of the files and upload the encoded root folder in substantially few operations compared to performing single uploads. The saving operation may include saving the files to the library 212 and/or to a storage medium (e.g., a CDN) that is in communication with the web server 215. The encoding operation may be performed in the ZIP file format. Other encoding formats are feasible as well.

The software that the ad agency 210 may use to upload files may be one of many different configurations. The virtual library device 220 has few compatibility restrictions to which the ad agency must adhere. One compatibility restriction is that the application program interface (API) of the web service is configured to receive bytes of an uploaded file in an encoded manner (e.g., ZIP file format). Other than that, the virtual library device 220 has few compatibility restrictions.

In some embodiments, the ad agency 210 may set up a scheduled automated synchronization of the library 212 with the virtual library 225. For example, the ad agency 210 may instruct the virtual library device 220 to synchronize the archive once weekly, once daily, or once hourly, etc.

The hierarchical file structure 400 of FIG. 4 is provided for explanatory purposes. There are a multitude of other conceivable configurations for a hierarchical file structure. Also, many other file types, besides the file types mentioned here, may be compatible with the system as well. Examples of other files types include GIF, PDF video, text and/or American Standard Code for Information Interchange (ASCII), among others.

Uploading a Hierarchical File Structure from an Ad Exchange

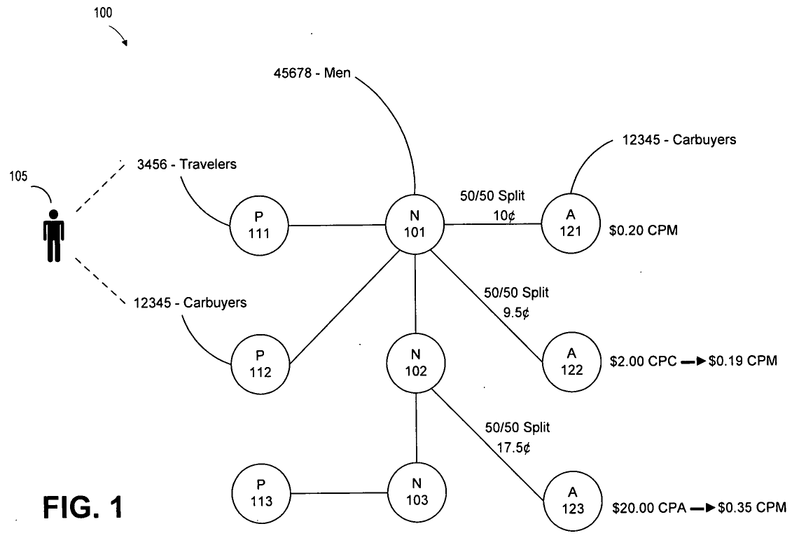

In some embodiments, the system 200 may operate in the context of an ad exchange. An exchange entity of an ad exchange may interface with the virtual library device 220 via the network 205. An exchange entity may be an ad agency 210 or another entity of the ad exchange. Exchange entities are described below with reference to FIG. 1. Then, the relationship between exchange entities and the system for uploading ad creatives is described below with reference to FIG. 3.

FIG. 1 shows exemplary exchange entities 100 of an ad exchange, in accordance with some embodiments. The exchange entities 100 include ad networks 101, 102, 103, publishers 111, 112, 113, and advertisers 121, 122, 123. Examples of an ad network include Yahoo!® Ad Network and MediaNews Group®. One of ordinary skill recognizes that the foregoing entities are exemplary and that the exchange entities 100 may contain other ad networks, publishers, advertisers, and/or other entities.

The publishers 111, 112, 113 preferably have content that is of interest to consumers 105 of such content. For instance, the publisher 112 may have a web page such as Edmunds.com that is directed to car buyers. Consumers 105 on the Internet may visit the web page to obtain the content provided. Some embodiments log the visits and/or activities of the consumers 105 on the web page, and further generate segments of consumers 105 who interact with the content. As shown in the figure, the publisher 111 may have content for travelers, while the publisher 112 has content for car buyers. Each segment preferably has a unique identifier that is unique to the segment, and is also unique to the entity. In this example, the segment “Car Buyers” for the publisher 112 is assigned the identifier “12345,” the segment “Travelers” for the publisher 111 is assigned the identifier “3456,” and the segment “Men” is assigned the identifier “45678” for the ad network 101.

As consumers 105 and/or segments of consumers 105 interact with the content provided by the publishers 111, 112, 113, “ad calls” are generated for the publishers' advertising inventory. Generally, in non-guaranteed delivery, the advertisers 121, 122, 123, bid to supply advertising to the available inventory. In this example, the advertiser 121 bids $0.20 CPM, the advertiser 122 bids $2.00 CPC, and the advertiser 123 bids $20.00 CPA. Some systems normalize the bids and/or costs to eCPM. Hence, the $2.00 CPC may be normalized to $0.19 CPM, and the $20.00 CPA to $0.35 CPM. Further, the advertisers 121, 122, 123 may have split fee arrangements with the ad networks 101, 102, 103. FIG. 1 illustrates 50/50 split fee arrangements between each advertiser 121, 122, 123, and each ad network 101, 102, 103. More specifically, for the $0.20 CPM the advertiser 121 pays for presentation of its advertising to consumers 105, the advertiser pays $0.10 CPM to the ad network 101. Other fee arrangements, however, are recognized by one of ordinary skill.

The advertisers 121, 122, 123 typically have advertising campaigns that include one or more ad creatives that promote a particular brand or product. The advertisers 121, 122, 123 may wish to specify certain criteria for each campaign such as, for example, maximum spend per day on the delivery of advertising, and/or criteria for targeted advertising. Examples of “hard targeting” include directing an advertisement to a particular gender and/or during a particular time of day. The advertisers 121, 122, 123 may further target particular consumers 105 and/or segments of consumers 105. Particular transactions and/or data have additional value for the exchange entities 100. For instance, one or more ads and/or campaigns for the advertiser 121 may have particular relevance to the Car buyers 12345.

In one implementation, an ad manager server maintains a history of attributes for several advertisements, and predicts the value per advertisement in relation to each publisher. The ad server may perform the foregoing alternatively, or in conjunction with, behavioral type targeting based on consumer data. In some of these embodiments, each consumer 105 has a cookie space that is used by various entities to store information. For instance, one or more entities of the exchange entities 100 advantageously write into a consumer's cookie space an integer identifier that corresponds to a particular consumer segment.

FIG. 3 is a block diagram of a system 300 for uploading a hierarchical file structure, with an exemplary placement of exchange entities 100, in accordance with some embodiments. The system 300 of FIG. 3 functions substantially the same as the system 200 of FIG. 2. A difference is that the ad agency 210 of FIG. 2 is replaced with the exchange entities 100 here. In FIG. 2, the ad agency 210 is in communication with the virtual library device 220. In contrast, in FIG. 3, one or more exchange entities are in communication with the virtual library device 220. Otherwise, the system 300 of FIG. 3 functions substantially the same as the system 200 of FIG. 2.

The exchange entities 100 include advertisers that want to advertise with publishers. An ad network (e.g., Yahoo!® Ad Network) in the exchange entities 100 may be authorized to deal and establish contracts on behalf of the advertiser. Another ad network (e.g., MediaNews Group®) may be authorized to deal and establish contracts on behalf of the publisher. As discussed above with reference to FIG. 1, there may be any number of entities between the outer entities, the advertiser 121 and the publisher 113.

The virtual library device 220 may receive requests to upload ad creatives of an ad campaign from one or more of the exchange entities 100, which are the users in this case. The virtual library device 220 uploads files in a manner that is described above with reference to FIG. 2.

### Method Overview

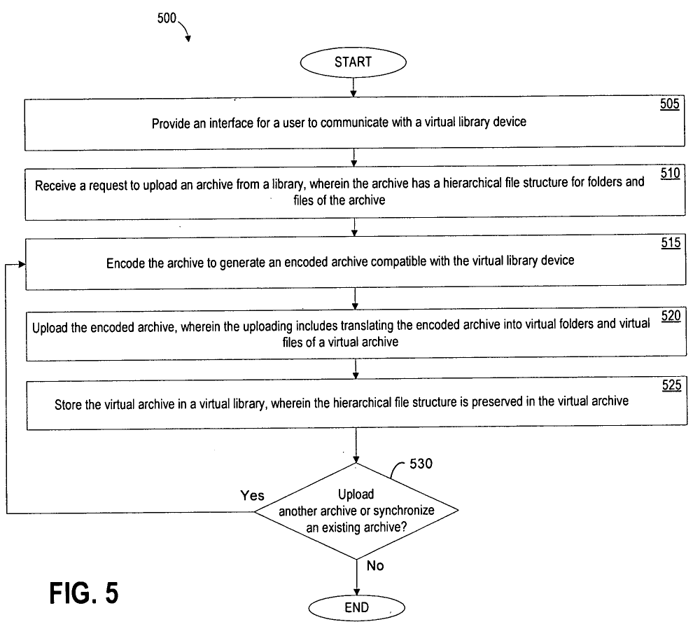

FIG. 5 is a flowchart of a method 500 for uploading a hierarchical file structure using a web service, in accordance with some embodiments. The steps of the method 500 may be carried out by the virtual library device 220 of FIG. 2. The method 500 starts in a step 505 where the system provides an interface for a user, such as an ad agency, to communicate with a virtual library device. The method 500 then moves to a step 510 where the system receives a request to upload an archive from a library. The archive has a hierarchical file structure for folders and files of the archive.

Next, in a step 515, the system encodes the archive to generate an encoded archive compatible with the virtual library device. The encoding may be performed using a ZIP file format or another file format. The method 500 then proceeds to a step 520 where the system uploads the encoded archive. This uploading includes translating the encoded archive into virtual folders and virtual files of a virtual archive. This uploading step may include uploading a new archive or synchronizing an archive with an existing archive in a virtual library. In a step 525, the system stores the virtual archive in a virtual library. The hierarchical file structure is preserved with respect to the virtual archive.

The method 500 then moves to a decision operation 530 where the system determines if another archive is to be uploaded or if an existing archive is to be synchronized. If another archive is to be uploaded or if an existing archive is to be synchronized, then the system returns to the step 515 where the system encodes the new (or modified) archive and continues. However, if another archive is not to be uploaded or if an existing archive is not to be synchronized, then the method 800 concludes.

Note that the present method may include other details and steps that are not discussed in this method overview. For example, the method may include steps for performing scheduled automated synchronization of archives. Other details and steps are discussed above with reference to the appropriate figures and may be a part of the present method, depending on the embodiment.

### Computer Readable Medium Implementation

Portions of the invention may be conveniently implemented by using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. Some embodiments may also be implemented by the preparation of application-specific integrated circuits or by interconnecting an appropriate network of conventional component circuits, as will be readily apparent to those skilled in the art.

Some embodiments may include a computer program product which is a storage medium (media) having instructions stored thereon/in which can be used to control, or cause, a computer to perform any of the processes of the invention. The storage medium can include without limitation any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), some implementations include software for controlling both the hardware of the general purpose/specialized computer or microprocessor, and for enabling the computer or microprocessor to interact with a human user or other mechanism utilizing the results of the invention. Such software may include without limitation device drivers, operating systems, and user applications. Ultimately, such computer readable media further includes software for performing aspects of the invention, as described above.

Included in the programming (software) of the general/specialized computer or microprocessor are software modules for implementing the teachings of the invention, including without limitation encoding an archive from a library to generate an encoded archive that is compatible with a virtual library device, and uploading the encoded archive, according to the processes described above.

### Advantages

The system for uploading hierarchical file structures preserves the hierarchy of the archive. Such hierarchical consistency is useful for many different projects. It is no longer necessary for authors of ad creatives to go through the laborious tasks of saving a single file, uploading a single file, saving another single file, uploading another single file, etc. Using the system described above, a user (e.g., an ad agency) may now save files (e.g., ad creatives), encode the root folder of the files and upload the encoded root folder in one operation or a few operations. The method that the ad agency 210 uses to upload may be one of many different configurations. The virtual library device 220 has few compatibility restrictions to which the ad agency must adhere.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for uploading a hierarchical file structure, the method comprising:
encoding an archive from a library to generate an encoded archive that is compatible with a virtual library device, wherein the archive has a hierarchical file structure for folders and files of the archive; and
uploading the encoded archive, wherein the uploading includes translating the encoded archive into virtual folders and virtual files of a virtual archive.

2. The method of claim 1, further comprising at least one of:
providing an interface through a web service for an ad agency to communicate with the virtual library device; and
receiving a request from the ad agency to upload the archive.

3. The method of claim 1, further comprising at least one of:
providing an interface through a web service for an exchange entity to communicate with the virtual library device; and
receiving a request from the exchange entity to upload the archive.

4. The method of claim 1, wherein the encoding comprises at least one of:
encoding a root folder of the archive;
encoding other folders besides a root folder of the archive; and
encoding all folders and files of the archive.

5. The method of claim 1, wherein the encoding comprises at least one of:
using a ZIP file format;
zipping a root folder of the archive;
zipping other folders besides a root folder of the archive; and
zipping all the folders and files of the archive.

6. The method of claim 1, wherein the encoding comprises encoding one or more files that are previously formatted in at least one of:
a JPEG file format;
a Shockwave Flash file format;
a Portable Networks Graphics file format;
a GIF file format;
a PDF file format;
a text file format;
an American Standard Code for Information Interchange file format; and
a file format that is compatible with the virtual library device.

7. The method of claim 1, wherein the uploading the encoded archive further includes at least one of:
uploading a new archive that does not have an existing virtual archive in a virtual library; and
synchronizing the encoded archive with an existing virtual archive in a virtual library.

8. The method of claim 1, wherein the uploading the encoded archive further includes uploading at least one ad creative of an ad agency.

9. The method of claim 1, further comprising at least one of:
storing the virtual archive in a virtual library; and
preserving the hierarchical file structure in the virtual archive such that the hierarchical file structure in the virtual archive is substantially equivalent to the hierarchical file structure in the archive from the library.

10. The method of claim 1, further comprising requiring substantially few operations of a user computer, wherein the user computer does not have to perform single uploads of single folders and single files.

11. A system for uploading a hierarchical file structure, wherein the system is configured for:
encoding an archive from a library to generate an encoded archive that is compatible with a virtual library device, wherein the archive has a hierarchical file structure for folders and files of the archive; and
uploading the encoded archive, wherein the uploading includes translating the encoded archive into virtual folders and virtual files of a virtual archive.

12. The system of claim 11, wherein the system is further configured for:
providing an interface through a web service for an ad agency to communicate with the virtual library device; and
receiving a request from the ad agency to upload the archive.

13. The system of claim 11, wherein the system is further configured for:
providing an interface through a web service for an exchange entity to communicate with the virtual library device; and
receiving a request from the exchange entity to upload the archive.

14. The system of claim 11, wherein the encoding comprises at least one of:
encoding a root folder of the archive;
encoding other folders besides a root folder of the archive; and
encoding all folders and files of the archive.

15. The system of claim 11, wherein the encoding comprises at least one of:
using a ZIP file format;
zipping a root folder of the archive;
zipping other folders besides a root folder of the archive; and
zipping all the folders and files of the archive.

16. The system of claim 11, wherein the encoding comprises encoding one or more files that are previously formatted in at least one of:
a JPEG file format;
a Shockwave Flash file format;
a Portable Networks Graphics file format;
a GIF file format;
a PDF file format;
a text file format;
an American Standard Code for Information Interchange file format; and
a file format that is compatible with the virtual library device.

17. The system of claim 11, wherein the uploading the encoded archive further includes at least one of:
uploading a new archive that does not have an existing virtual archive in a virtual library; and
synchronizing the encoded archive with an existing virtual archive in a virtual library.

18. The system of claim 11, wherein the uploading the encoded archive further includes uploading at least one ad creative of an ad agency.

19. The system of claim 11, wherein the system is further configured for:
storing the virtual archive in a virtual library; and
preserving the hierarchical file structure in the virtual archive such that the hierarchical file structure in the virtual archive is substantially equivalent to the hierarchical file structure in the archive from the library.

20. The system of claim 11, wherein the system is further configured for requiring substantially few operations of a user computer, wherein the user computer does not have to perform single uploads of single folders and single files.

21. A computer readable medium carrying one or more instructions for uploading a hierarchical file structure, wherein the one or more instructions, when executed by one or more processors, cause the one or more processors to perform the steps of:
encoding an archive from a library to generate an encoded archive that is compatible with a virtual library device, wherein the archive has a hierarchical file structure for folders and files of the archive; and
uploading the encoded archive, wherein the uploading includes translating the encoded archive into virtual folders and virtual files of a virtual archive.
